(19) United States
(12) Patent Application Publication
(10) Pub. No.: US 2026/0221297 A1
(43) Pub. Date: Jul. 30, 2026

(54) COATING OF PLASMA-WALL INTERACTION COMPONENTS IN NUCLEAR POWER GENERATORS

(71) Applicants: ENEA - AGENZIA NAZIONALE PER LE NUOVE TECNOLOGIE, L'ENERGIA E LO SVILUPPO ECONOMICO SOSTENIBILE, Rome (IT); TESSITURA TELE METALLICHE ROSSI SRL, Villa Guardia (CO) (IT)

(72) Inventors: Matteo IAFRATI, Rocca Priora (RM) (IT); Guido ROSSI, Como (CO) (IT)

(21) Appl. No.: 19/145,819

(22) PCT Filed: Jan. 9, 2024
(86) PCT No.: PCT/IB2024/050199

§ 371 Date: Jul. 3, 2025

(30) Foreign Application Priority Data
Jan. 12, 2023 (IT) 102023000000333

(51) Int. Cl. G21B 1/13; G21B 1/05

(52) U.S. Cl. CPC G21B 1/13; G21B 1/057

(57) ABSTRACT

A coating of plasma-wall interaction components in machines for the magnetic confinement of thermonuclear plasmas, comprising a capillary retaining structure defining a predefined containment volume, said containment volume being adapted to retain at least one liquid metal; said capillary retaining structure comprising at least one metal multi-wire cable arranged according to an entangling pattern.

The present invention relates to the field of research and applications in the context of nuclear fusion, with particular reference to the problems relating to the coating materials of appropriate structural parts present in the machinery responsible for the confinement of plasmas of thermonuclear interest (for example, “tokamak” machines), and more in particular with reference to the structure of the so-called “diverter” present in such machinery.

The diverter is, in the technical field pertaining to the present invention, that part of the wall on which the plasma is diverted (which naturally diffuses perpendicularly to the magnetic field lines) which is typically found- and circulates-inside nuclear fusion reactors, and can generally be considered as making a “first wall” directly interfaced with a plasma of fusion interest.

In the field of fusion, the idea of using a liquid metal as a material directly facing the plasma to mitigate the effects of the plasma (erosion, fusion, damage, neutron embrittlement) on conventional solid materials, such as tungsten, is increasingly emerging. If used within a magnetic confinement fusion device, the liquid metal must necessarily be confined: the electric current induced on the surface of the metal (mainly by magnetic flux variation or thermoelectric effect) would concatenate with the pre-existing magnetic field, giving rise to the formation of drops. There are many approaches to confinement, including those of a “static” type (i.e., in the absence of forced circulation of the liquid metal), among which confinement by capillarity stands out. This consists in retaining the metal in a porous structure which allows counteracting the forces acting on the liquid, which would like to disperse it in the machine.

The approaches known so far (and known in the literature) highlight few relevant strands: creation from wires, sintering of material with variable porosity, creation of a surface castellation. The last option has proved to be the least effective due to a very small capillary force against a considerable implementation effort. The second technology would theoretically allow very high capillary pressures, the main disadvantage is the absence of control over the percentage of open and closed capillarity, greatly reducing the potential of the product. The final solid object is typically fragile. The very broad distribution of the equivalent capillary radius can cause considerable variations in the confining force as the surface varies.

It is the main object of the present invention to overcome the aforesaid problems by providing a tungsten capillary structure made by weaving a pure tungsten multi-wire cable (yarn), in which the creation parameters have been designed to obtain a high capillary pressure aimed at using these structures with liquid metal, in particular in machines of fusion interest (such as the so-called “tokamak” machines) within the context of the plasma-wall interaction.

This has been achieved, according to the invention, by providing a coating of plasma-wall interaction components in machines for the magnetic confinement of thermonuclear plasmas, as defined in the claims appended hereto.

Said coating comprises a capillary retaining structure defining a predefined containment volume adapted to retain at least one liquid metal; in which said capillary retaining structure comprises at least one metal multi-wire cable arranged according to an entangling pattern.

A better understanding of the invention will be achieved from the following detailed description and with reference to the accompanying drawings showing, by way of a non-limiting example, a preferred embodiment.

In the drawings:

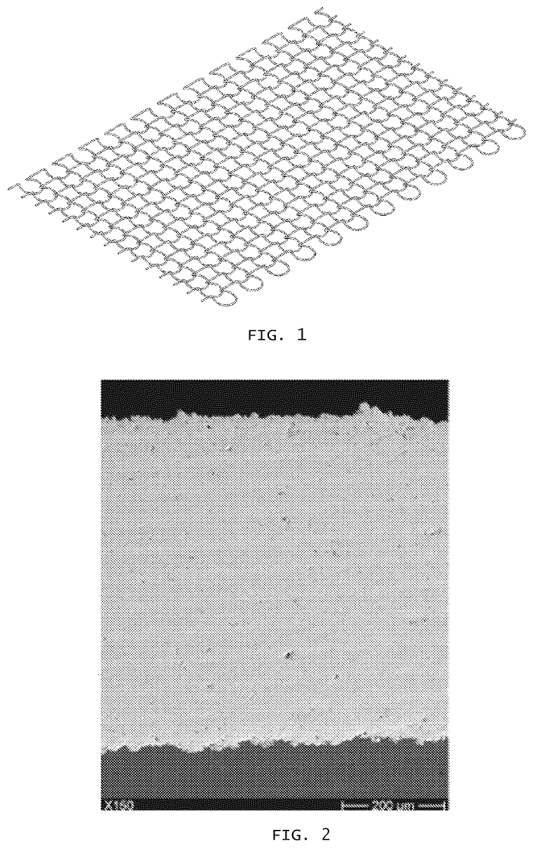

FIG. 1 diagrammatically shows a preferred “entangling pattern” of the coating with the capillary structure according to the present invention; and

FIG. 2 shows an electron microscope photograph of a structural component of the coating according to the invention.

With reference to FIG. 1, the technology based on weaving wires according to the invention is the most promising for both production simplicity and possibility of process industrialization, and for the intrinsic strength and flexibility thereof.

The inventive concept underlying the invention consists in the use of a multi-wire cable in material comprising tungsten to weave a material characterized by a porous structure capable of retaining liquid metal against hydrostatic pressure and other forces of various nature (such as those electromagnetic forces which can be generated inside the tokamak).

According to the invention, tungsten has been selected because it is resistant to corrosion by liquid metal, is hardly affected by problems of a neutron nature and has a very high fusion temperature.

One of the peculiar features of the invention is the innovative use of a multi-wire cable, which has greatly reduced the effective radius guiding the capillarity phenomenon. The effective radius of the structure is inversely proportional to the capillary pressure, i.e., to the performance, in terms of pressure, of the object itself. In the trials, this has allowed reaching the height values of the hydrostatic liquid column never found before in the literature or in other currently known experiments.

The research which led to the aforesaid trials was initially guided by the following formula, which specifies how the capillary pressure P_{c} is determined:

$${P}_{c} = \frac{2 \cdot σ \cdot cos θ}{{r}_{eff}} \\ θ - wetting angle \\ {r}_{eff} - pore radius \\ σ - surface tension$$

### Where:

The “wetting angle” is defined as the angle formed by the tangent to the liquid phase interface and the tangent to the solid surface, at the contact line between the phases. It is usually expressed in radians [rad];
The “pore radius”, i.e., the effective radius of the porous structure, is defined as the equivalent radius of a cylindrical capillary which originates the same capillary pressures as the porous structure. In SI, it is expressed in meters [m];
The “surface tension” is defined as the mechanical tension which is exerted on the surface of a liquid, in SI it is expressed in newtons per meter [N/m].

It is important to note that the mesh obtained by weaving the multi-wire cable according to the present invention preferably has the entangling pattern shown in FIG. 1, and therefore such mesh can be used as a material directly exposed to plasma in a machine of interest for controlled thermonuclear fusion. In this case, the use of a solution based on the concept of a porous structure which confines liquid metal advantageously has an intrinsic insensitivity to damage induced by fast neutrons (DPA) and an ability to regenerate the surface in transient or accidental events (e.g., ELMs or disruption).

Experiments in tokamaks (including the Frascati Tokamak Upgrade—FTU) have demonstrated the existence of a “steam shield” process which is triggered if a plasma destruction involves the liquid metal contained in the structure. In fact, the liquid metal subject to a very high heat flow forms a thin layer of steam which is in turn ionized, redistributing the thermal energy in the form of radiation over the entire solid angle. This phenomenon showed no damage to the porous structure (always obtained with the entangling pattern shown in FIG. 1) even in case of transients with extremely high thermal load values.

The flexibility of the coating obtained according to the present invention, as well as the possibility of a shaped weave, allow an optimal adaptation of the coating to the support and cooling structure of the diverter.

The material in contact with the plasma can benefit from very reduced thicknesses, favoring heat exchange with the cooling structure and increasing the thermal load removal capacity in steady state. Any consumption of material by sputtering and/or evaporation can be promptly replaced by a liquid metal tank placed in direct contact with the spongy material described so far, exactly as oil lamps also work with the wick thereof.

The coating mesh thus made can be easily soaked in liquid metal and shaped to best adhere to any support structure. The support structure will be provided with an anti-corrosive surface coating and also wetted with the liquid metal (such as that in FIG. 2). This will ensure optimal heat exchange between the capillary structure of the coating and the heat removal system.

In the same FIG. 2, it can be seen that the image shown therein shows the coating of the invention made of tungsten, which protects the copper of a cooling base from the corrosive attack of tin in which the product is soaked.

Another peculiar feature of the invention is the innovative use of a multi-wire cable, i.e., intrinsically consisting of very small capillaries, to make a porous tungsten structure which can be used to confine the liquid metal (in particular in tokamak-type applications).

Moreover, it should be noted that the present invention preferably includes the following geometric/dimensional features related to the capillary retaining structure and the materials forming it:
the wires forming the multi-wire cable can be the mutually identical or different and each of them can be made of;
   pure tungsten;
   metal alloys containing a predetermined percentage by weight and/or mass of tungsten (for example, between 80% and 99.999%);
   chemical compositions containing tungsten and “doped” with other elements or substances such as potassium (K) or rhenium (Re);
   tungsten compounds;
an average size of the cavities (for example, an “equivalent diameter”, if such cavities are approximated to cylindrical spaces or in any case having a circular section) present within the capillary retaining structure between 10⁻⁴ mm and 10⁻² mm;
an average diameter of the single wire forming the multi-wire cable between 0.005-0.020 mm;
a total number of single wires forming the multi-wire cable between 5 and 25, and preferably for example equal to 14;
an overall diameter of the multi-wire cable between 0.050 mm and 0.500 mm.

It is worth noting that the present invention can also be adapted to retaining a wide range of liquid metals (even with high corrosivity), as long as the latter are adapted to effectively carry out the thermal insulation functions thereof with respect to the plasma ring extending inside the machinery which uses controlled thermonuclear fusion: for example tin, lithium, indium, gallium.

During the experiments of the invention, several porous structures of pure tungsten were made, which successfully passed the wetting tests and managed to effectively confine the liquid metal. Moreover, the tests with tin showed that the liquid column can exceed several tens of cm, equivalent to a capillary pressure that has never been reached before in previous experiments in the field.

It is also advantageously possible to compact/sinter the porous structure with a mold having the same geometry as the component to be coated. This increases the ease of application of the invention, improving the adhesion of the porous structure with the substrate and consequent heat exchange in case of application to a liquid metal diverter: in other words, the subsequent formation of the porous structure (with a mold having the same geometry as the component to be coated) also allows providing a smooth and continuous surface in view of the plasma.

Lastly, it is useful to note that said entangling, or weaving, pattern is defined by at least one of the following textile patterns:
plain fabric;
smooth herringbone fabric;
cross-woven fabric.

1. A coating of plasma-wall interaction components in machines for the magnetic confinement of thermonuclear plasmas, said machines being adapted to carry out controlled thermonuclear fusion phenomena, characterized in that it includes a capillary retaining structure comprising at least one metal multi-wire cable; wherein said metal multi-wire cable is woven according to a entangling pattern configured to define a predefined containment volume, said containment volume being adapted to retain at least one liquid metal.

2. A coating according to claim 1, characterized in that said entangling or weaving pattern is defined by at least one of the following textile patterns:
plain fabric
smooth herringbone fabric
cross-woven fabric.

3. A coating according to claim 1, characterized in that each of the wires forming said at least one metal multi-wire cable is made of at least one of the following materials:
pure tungsten, said pure tungsten being present in a purity percentage between 99,000% and 99.999%;
a metal alloy containing a percentage by weight and/or by mass of tungsten between 80% and 99.999%);
steel adapted to interact with said liquid metal, said steel comprising a steel of AISI304 type and/or AISI316 type;
superalloy adapted to interact with said liquid metal.

4. A coating according to claim 3, characterized in that said superalloy comprises at least one of the following materials:
INCONEL, preferably Inconel 600/625;
Incoloy 800/825/A286;
Fecralloy;
Hastelloy;
Constantan;
Monel;
Nickel;
Duplex/SuperDuplex.

5. A coating according to claim 1, characterized in that said capillary retaining structure defines a multiplicity of cavities adapted to retain said liquid metal.

6. A coating according to claim 5, characterized in that it has an average size of said cavities, present within the capillary retaining structure, which is between 10⁻⁴ mm and 10⁻² mm.

7. A coating according to claim 1, characterized in that said at least one multi-wire cable consists of a bundle of wires or cables or bands, said wires or cables or bands being:
mutually parallel to one another; or
mutually twisted together.

8. A coating according to claim 7, characterized in that the average diameter of each of the wires or cables or bands forming the multi-wire cable is between 0.005 mm and 0.030 mm.

9. A coating according to claim 7, characterized in that the total number of wires forming said at least one multi-wire cable is between 5 and 30, and preferably is equal to 14.

10. A coating according to claim 7, characterized in that the overall diameter of said at least one multi-wire cable is between 0.050 mm and 0.500 mm.

11. A coating according to claim 1, characterized in that said capillary retaining structure defines a surface roughness between 0.025 mm and 0.25 mm.

12. A coating according to claim 1, characterized in that said capillary retaining structure is positionable directly exposed to a plasma lying in a machine utilizing controlled thermonuclear fusion phenomena.

13. A coating according to claim 1, characterized in that said capillary retaining structure is flexible and shapeable.

14. A coating according to claim 1, characterized in that the capillary retaining structure has an overall thickness between 0.5 mm and 10 mm, said coating being interposed between a confinement wall of said machine utilizing controlled thermonuclear fusion phenomena and said plasma.

15. A coating according to claim 1, characterized in that it further comprises irrigation and diffusion means for said liquid metal operatively enslaved to said capillary retaining structure and adapted to send a predetermined flow of liquid metal, in case of at least partial loss of said liquid metal due to sputtering and/or evaporation phenomena.

16. An apparatus utilizing controlled thermonuclear fusion phenomena, configured to generate a plasma occupying an operating space and comprising a confinement wall within which said plasma lies, characterized in that it comprises at least one coating according to any one of the preceding claims interposed between said containment wall and said plasma; wherein said coating is configured to cooperate with magnetic confinement means for thermonuclear plasmas being cooperatively active with said confinement wall and/or said operating space.

17. An apparatus according to claim 16, characterized in that it is a tokamak-type fusion reactor.
